(19) United States
(12) Patent Application Publication
(10) Pub. No.: US 2026/0311198 A1
(43) Pub. Date: Oct. 8, 2026

(54) SYSTEMS AND METHODS FOR AUTOMATED DATA ENRICHMENT, PRODUCT GROUPING, AND MEDIA DELIVERY FOR LEAD ENGAGEMEN

(71) Applicant: Daniel Holloway, Dublin, OH (US)

(72) Inventor: Daniel Holloway, Dublin, OH (US)

(21) Appl. No.: 19/329,776

(22) Filed: Sep. 16, 2025

Related U.S. Application Data
(60) Provisional application No. 63/782,194, filed on Apr. 2, 2025.

(51) Int. Cl. G06Q 30/0201

(52) U.S. Cl. CPC G06Q 30/020121

(57) ABSTRACT

Systems and methods are disclosed for generating and delivering personalized media assets based on enriched lead data. A computing system receives lead records from one or more sources, assigns unique identifiers, and enriches the records with supplemental data from internal or external sources. The system generates customized media assets, such as personalized offers or proposals, stores them in a content delivery network, and creates unique access links. These links are delivered to the entities described by the lead records via electronic communication channels. The system enables rapid, scalable, and data-driven engagement.

### INCORPORATION BY REFERENCE

This application claims the benefit of U.S. Provisional Patent Application No. 63/782,194, filed Apr. 2, 2025, under 35 U.S.C. § 119(e). The entire disclosure of the provisional application, including but not limited to the specification and drawings, is hereby incorporated by reference in its entirety as if fully set forth herein.

### FIELD

The subject matter described herein relates generally to data processing systems, and more particularly to systems and methods for receiving, enriching, organizing, and utilizing data records for the automated generation and delivery of customized media content through electronic communication channels.

### BACKGROUND

Data records associated with individual leads, customers, or prospects can be received from a variety of sources and in a variety of formats. These records can include partial or incomplete information and may lack uniformity across entries, making it difficult to derive actionable insights or generate personalized communications in an efficient manner. In some contexts, significant manual effort can be required to enrich, clean, and prepare such data sets before they are suitable for use in downstream processes such as product matching, pricing analysis, or marketing content creation.

There is a growing interest in approaches that enable the transformation of disparate data records into a standardized format, enriched with supplemental data from third-party sources, and subsequently organized into logical groupings that facilitate targeted engagement. Once such data has been processed, it can be desirable to generate tailored media assets—such as marketing flyers—based on selected characteristics of each record or group, and to associate those assets with unique identifiers for delivery through electronic communication systems. Efficient implementation of such functionality can provide improvements in turnaround time, accuracy, engagement, and operational scalability across marketing, sales, and customer relationship workflows.

Systems and methods capable of ingesting, enriching, sorting, transforming, and utilizing data sets in an integrated and automated manner that can support improved performance across a range of commercial and industrial applications are needed.

### BRIEF DESCRIPTION OF THE DRAWINGS

The following drawings illustrate by way of example and are included to provide further understanding of the disclosure for purpose of illustrative discussion of the examples of the disclosure. No attempt is made to show structural details of the embodiments in more detail than is necessary for a fundamental understanding of the disclosure, the description taken with the drawings making apparent to those skilled in the art how the several forms of the disclosure may be embodied in practice. Identical reference numerals do not necessarily indicate an identical structure. Rather, the same reference numeral may be used to indicate a similar feature or a feature with similar functionality. In the drawings:

FIG. 1 illustrates an example method for receiving lead records, assigning unique identifiers, generating custom deliverables, and delivering those deliverables to users.

FIG. 2 illustrates an example method for enriching lead records with data from external sources prior to the generation and delivery of personalized media assets.

FIG. 3 illustrates an example method for receiving, enriching, generating, storing, and delivering media assets using unique links, in a fully integrated end-to-end system.

FIG. 4 illustrates an example system architecture comprising a content generating computing device, a data source network, and a content delivery network for enriching lead records and delivering personalized media content to consumers.

FIG. 5 illustrates a computing device configured to perform one or more operations of lead ingestion, enrichment, media generation, and delivery, including internal components such as a processor, memory, data bus, network controller, and I/O controller.

FIG. 6 illustrates an example method for generating and delivering personalized financial offer media assets, including enriched property and financial data, particularly suited for mortgage and refinance applications.

FIG. 7 illustrates a computing device configured to perform one or more operations of lead ingestion, enrichment, media generation, and delivery, including internal components such as a processor, memory, Northbridge, Southbridge, network controller, USB controller, and IDE controller.

FIG. 8 illustrates a computing device configured to perform one or more operations of lead ingestion, enrichment, media generation, and delivery, including internal components such as a processor, memory, data bus, network controller, I/O controller, and AI Accelerator.

### DETAILED DESCRIPTION

Systems and methods are provided for processing personalized lead records and generating personalized media content for delivery to the associated entities. In various implementations, a system can receive one or more lead records from one or more sources, assign unique identifiers to the records, enrich the records with supplemental data obtained from internal or external sources, and generate custom media assets based on enriched information. These media assets may be stored in a content delivery network and associated with unique access links. The links can be transmitted to the entities described by the lead records through electronic communication channels such as SMS, MMS, email, rich communication services (“RCS”), or other messaging protocols.

### System

The system as provided by this disclosure receives, processes, enriches, organizes, and deploys data records for the purpose of generating and delivering personalized media assets. The system can operate on input data sets including the individual lead records. The lead records can include information such as names, phone numbers, property addresses, financial data, or other attributes relevant to commercial or marketing operations. Lead records will more thoroughly discussed below.

The data standardization process can begin with the import of the data set into a local or network-based environment. The data is processed to be put into an expected and standardized form. The data may be encoded or put into a form, sufficient for parsing and/or computer operations.

This data set is then subjected to an enrichment phase during which supplemental data is retrieved from one or more third-party data providers using various communication protocols, such as an API. These enrichment processes can involve, for example, appending phone numbers, validating contact information, obtaining property valuations, retrieving debt obligations, or determining other criteria associated with the records. Multiple enrichment sources can be queried in parallel or in sequence, and data from the source exhibiting the highest observed conversion accuracy may be selected for integration. Enrichment of lead records may include verification of contact data, retrieval of property information, integration of financial attributes, and calculation of derived values, such as loan-to-value ratios or prequalification thresholds. Enrichment sources may be queried through application-program interfaces (“APIs”) or other communication protocols, and the system may apply logic to prioritize or reconcile data from multiple sources.

Once enriched, the system can apply logic to classify the records into discrete product and pricing groups. Each group can be formed by identifying shared qualifying characteristics across multiple records. The classification process can utilize predefined rules, formulaic calculations, or machine learning models, depending on system configuration.

Following enrichment, classification occurs. Product and pricing groups are formed. Then, the system can generate API calls for each group to retrieve group-specific product or pricing data. This enables streamlined generation of downstream marketing content and ensures uniform treatment of similarly situated records.

Following the classification and enrichment stages, the system can proceed to the generation of media assets. Media assets, which will be more thoroughly discussed below, can include a variety of formats, including images, video files, PDFs, HTML markup, or structured data formats. The system can generate these assets by populating predefined templates with enriched lead data and optionally incorporating group-level characteristics or rules-based content selection. In one implementation, the system receives user input selecting one or more records for which marketing media is to be created. Each selected record is associated with a product and pricing group, and the data relevant to that group—together with any unique information from the selected record —is used to populate a template for a marketing flyer. The flyer can include personalized messaging, product offers, pricing terms, or other content tailored to the recipient.

The system then renders the flyer and stores it in a content delivery network (“CDN”) as an deliverable file format, such as an image file. Each flyer stored in the CDN is associated with a unique link that can be generated programmatically. This link is deterministically tied to the enriched lead record, ensuring that each record corresponds to one or more unique media assets.

Once the media is stored and associated with a link, the lead record can be injected into a customer relationship management (“CRM”) system. Within the CRM, users can move the record into a designated workflow stage, which can trigger one or more automated communications. These communications may be executed via omnichannel delivery mechanisms, such as SMS, MMS, RCS, in-app messaging services, messaging applications, application-based digital communications, or email, depending on system configuration and user preferences. As part of this process, the CRM can retrieve the media flyer using the unique link from the CDN and incorporate it into the outbound message.

The system is designed to support the creation and delivery of multiple unique flyers per record, enabling fine-grained targeting and repeated engagements across multiple communication vectors.

An architecture of the system may support distributed deployment, with components for lead ingestion, enrichment, media generation, storage, and delivery operating across networked environments. The system can include computing devices with memory, processors, I/O controllers, and network interfaces configured to coordinate the operations described.

These and other implementations can support improved automation, reduced time to engagement, enhanced targeting accuracy, and scalable content distribution across a range of commercial, marketing, or financial applications.

### Lead Records

Lead records can comprise structured data entries representing individual consumers, businesses, or other entities relevant to a commercial or marketing campaign. Each lead record can include a variety of fields, such as contact information (e.g., name, email address, phone number), property details (e.g., address, assessed value, loan balance), demographic indicators, engagement history, or other attributes relevant to segmentation, targeting, or qualification processes.

The system can support ingestion of lead records from multiple sources, including but not limited to spreadsheets, CRM exports, third-party lead generation platforms, or direct API integrations. Upon ingestion, each lead record can be assigned a unique identifier that is preserved throughout all downstream operations to enable traceability, individualized processing, and reliable association with media assets, enrichment data, and communication events.

The identifier can be generated in a variety of ways depending on system configuration and the nature of the data. In some implementations, a universally unique identifier can be generated at the time of ingestion to ensure global uniqueness, independent of record content. In other implementations, the identifier may be derived from intrinsic characteristics of the record, such as a customer number, email address, phone number, or physical address, particularly where such fields are expected to be unique within a given data set or operational context.

Where identifiers are derived from data attributes, the system can encounter ambiguity or collision when input data is incomplete, outdated, or duplicated. For example, multiple entities may share the same phone number or address, or a single entity may appear across multiple data sets under slightly different representations. These conditions can result in conflicting data being associated with a single identifier or a single entity being improperly split across multiple identifiers.

To address these scenarios, the system can apply validation logic during ingestion and enrichment to detect and flag inconsistencies. If an identifier is determined to be non-unique or if record data appears to conflict with other entries, the system can take one of several actions. In privacy-sensitive contexts or where data integrity cannot be confirmed, the system may default to discarding the affected record to prevent misattribution or unintended disclosure. Alternatively, the system can apply AI-based or algorithmic disambiguation techniques to separate the data into multiple inferred entities. These techniques may include probabilistic matching, rule-based comparisons, clustering, or analysis across fields such as name, address, phone number, property information, and historical transactions.

If the system determines with high confidence that the record represents multiple distinct entities, it can assign new unique identifiers accordingly. Where confidence thresholds are not met, or where privacy considerations dominate, the system can be configured to suppress further processing of the record.

Lead records and associated metadata can be stored in a database or persistent memory store accessible to various modules of the system. The database can include auxiliary tables for enrichment results, classification metadata, delivery state tracking, and media associations. In some configurations, the records may be stored in encrypted form, with access gated by role-based permissions. Versioning can also be supported to preserve historical integrity and facilitate rollback, auditing, or comparison operations. This architecture supports robust, privacy-aware, and scalable handling of lead data throughout the system lifecycle.

### Enrichment Data

Enrichment refers to the process of augmenting lead records with additional data obtained from one or more external or internal sources. The purpose of enrichment is to improve the completeness, accuracy, and utility of lead data prior to classification, personalization, and media generation. Enrichment enables the system to produce more relevant, targeted, and actionable content by filling in missing fields, verifying existing data, or deriving new insights from known attributes.

The enrichment process can be triggered automatically upon ingestion of a lead record or executed as a batch or on-demand operation. It may rely on direct API calls, secure file transport protocol (“SFTP”) file transfers, webhook integrations, or internal lookups against proprietary databases. The system may query multiple enrichment sources in parallel or in sequence and can apply data quality logic to prioritize or select the most reliable response. Redundancy and source fallback may be supported to maximize coverage.

A wide range of data types can be used for enrichment, depending on the application domain. Contact-related enrichment may include phone numbers, email addresses, mailing addresses, and identity validation. This type of enrichment can verify whether a phone number is valid, determine the associated carrier, or confirm whether a mailing address is residential or commercial. In real estate, lending, or insurance applications, property enrichment may retrieve characteristics such as square footage, lot size, number of bedrooms and bathrooms, parcel identification, year built, recent sale prices, tax assessment values, or estimated market value. The system may also obtain lien information, ownership history, and mortgage position data.

Financial enrichment may include current loan balances, interest rates, credit risk indicators, tradeline summaries, and payment history. From these attributes, the system may derive values such as loan-to-value ratio, debt-to-income ratio, or available equity. Where permitted, demographic or behavioral data may be used to enhance targeting and segmentation. This may include age bands, household income range, marital status, homeownership status, or recent digital engagement signals, such as browsing or purchase activity. Transactional or historical enrichment can reflect a lead's prior engagement with a business, such as past quotes, loan applications, renewals, or communication history, supporting remarketing and retention strategies. Geographic or regional data may also be relevant, including census tract information, neighborhood market conditions, regional eligibility criteria, or regulatory overlays that influence pricing or qualification.

The enriched data may be integrated directly into the lead record, stored as auxiliary metadata, or cached in a separate enrichment profile associated with the record's unique identifier. The system may also apply internal logic to resolve conflicting data, calculate derived values, or determine whether a record meets predefined thresholds for further processing. In cases of conflicting or ambiguous data, enrichment logic may rank sources by observed reliability, recency, or match specificity. If a record cannot be reliably enriched—due to poor data quality, unavailability of third-party matches, or policy restrictions—the system may flag it for review, exclude it from downstream workflows, or apply fallback messaging logic to indicate incomplete qualification.

Enrichment is a critical element of the overall workflow, acting as the bridge between raw lead data and intelligent content generation. By enabling high-resolution targeting, personalization, and eligibility determination, enrichment significantly enhances the effectiveness of the media assets ultimately delivered to consumers.

### Enrichment Trustworthiness

In various implementations, the system includes mechanisms to assess and record the provenance and trustworthiness of data retrieved from enrichment sources. For each external or internal data provider, the system can maintain a source profile comprising metadata such as historical accuracy, data freshness, latency, cost per call, and observed conversion effectiveness. The system may record match confidence scores, coverage percentages, and frequency of successful resolution for specific data types (e.g., phone validation, property value estimation, credit indicators). Based on these metrics, the system may assign a trust score to each source, which can be updated over time through continuous observation and feedback.

In scenarios where multiple sources return conflicting enrichment values for the same data field, the system can apply source weighting or hierarchical resolution logic. For example, a credit bureau with regulatory standing may be weighted more heavily than a consumer aggregator. The weighting function may be dynamically computed based on context—e.g., prioritizing recency for financial data, or completeness for property records. In some embodiments, the system uses a rule-based engine or a machine learning model trained on historical enrichment accuracy to determine which source's data to select or whether to discard the field entirely due to ambiguity. If confidence thresholds are not met, the record may be flagged for manual review, deferred, or processed using fallback messaging logic that reflects the uncertainty.

The system may also maintain an internal provenance ledger that tracks which enrichment sources contributed to each field within a lead record, along with associated timestamps, version identifiers, and trust scores. This ledger can be queried for audit, debugging, or optimization purposes and supports compliance with data quality and governance requirements. Where required, provenance data may be exposed through APIs or dashboards to enable external validation or override by privileged users.

### Media Assets

Within the described system, a media asset refers to any generated content that is created, customized, stored, and delivered in connection with a lead record. Media assets serve as the primary mechanism by which enriched data and targeted messaging are communicated to the subject of a lead record. The system is designed to support the generation and handling of a wide variety of media asset types to accommodate different use cases, content formats, communication channels, and regulatory or technical requirements.

Media assets can include literal media content such as raster images (e.g., JPEG, PNG), vector graphics, and video files (e.g., MP4). These assets are well-suited for visually engaging communications, such as marketing flyers, animated offers, or introductory videos. Static image formats are frequently used when quick rendering and wide compatibility across devices are desired, while video assets may be employed where a more immersive or demonstrative experience is appropriate.

In addition to visual media, the system can generate textual and document-based assets, such as PDFs, DOCX files, plain text files, and HTML markup. PDF assets are particularly common in regulated industries, such as finance, due to their fixed layout, auditability, and compatibility with digital signing workflows. These may include formal offers, term sheets, estimates, quotes, or legal disclosures. HTML-based assets are frequently used for in-browser rendering and responsive presentation on mobile or desktop devices and may include dynamic elements such as embedded videos, charts, or collapsible sections.

In some configurations, media assets may also include raw structured content such as JSON, XML, or CSV data, where the target application expects to ingest or render the content programmatically. This is useful in B2B integrations or systems where the recipient is a software agent rather than a human user.

Media assets can be generated using template-driven rendering engines, which take record-specific data and apply it to predefined layouts, styles, and content blocks. Templates may vary by asset type, lead classification, or business logic, enabling a high degree of personalization. Conditional formatting, data-driven content selection, and rule-based inclusion of legal disclaimers or eligibility terms can all be supported.

After generation, each media asset is stored in a content delivery network or other accessible storage infrastructure. The asset is associated with a unique identifier and, in most cases, a unique access link. These links may be constructed to expire after a set time, restrict access by IP or token, or otherwise conform to compliance and security requirements. Where required, encryption at rest or in transit can be applied.

The system may track metadata associated with each media asset, including generation timestamp, source template ID, lead record ID, delivery status, access history, and engagement metrics. This information can be used for compliance logging, marketing analytics, A/B testing, or follow-up campaign planning.

Media assets serve as the final output of the system's automated workflow and are the primary means by which personalized, data-driven communication is delivered to the lead. Their form, structure, and content may vary depending on the context—ranging from a simple personalized flyer to a complex, multi-page refinance offer with embedded disclosures—and the system is designed to flexibly support that entire range of asset types.

### Template Management System

In various implementations, the system includes a template management subsystem that enables the definition, storage, versioning, and rule-based deployment of media templates used for generating deliverables. A template refers to a parameterized layout structure—such as a document, image frame, or HTML scaffold—into which enriched lead data and system-generated variables can be programmatically inserted to produce a customized media asset.

Templates may be authored and defined using a structured markup language, WYSIWYG editor, or proprietary templating syntax. Each template may include static design elements (e.g., headers, images, branding assets), dynamic content blocks (e.g., personalized messages, pricing fields), and conditional logic tags (e.g., if, else, match) that control rendering behavior based on data attributes or enrichment outputs. Templates may be stored in a version-controlled repository, with metadata fields indicating version number, creation and modification timestamps, creator identity, associated campaign or business line, and applicable file formats (e.g., PDF, JPEG, HTML, MP4). Templates may be uniquely identified by a template ID or hash value, allowing deterministic association with media assets.

The system may map templates to one or more business rules, enrichment triggers, or record classifications. For example, a refinance offer template may only be activated when the enriched lead record includes a valid loan-to-value ratio below a specified threshold, while a cash-out equity template may be triggered when estimated available equity exceeds a predefined amount. These mappings may be expressed declaratively in rule tables, conditionally in code, or dynamically via ML-based template selection models. In some configurations, templates are organized into template groups associated with record clusters or market segments, and selected via scoring functions at runtime.

Prior to deployment, templates may be previewed in context through administrative interfaces as described above. The preview functionality allows a user to select one or more lead records and view the fully rendered media asset as it would appear to the recipient. The system may provide inline editing tools to modify static content, override populated values, or simulate variations under different enrichment conditions. Users may manually approve or reject a template for a given use case, and may create derivatives (forks) of existing templates for A/B testing, jurisdictional compliance, or brand segmentation. Templates marked as deprecated or superseded may be retained for historical record-keeping but excluded from runtime selection.

Templates may be stored in local or cloud-based persistent storage, such as object stores, versioned databases, or distributed file systems. Access to template files and metadata may be controlled through role-based access control (RBAC) and audit-logged for regulatory compliance. In distributed deployments, templates may be replicated across edge nodes or cached in content delivery infrastructure to reduce rendering latency and enable localized customization. Template rendering engines may pull template definitions directly from memory or retrieve them on demand from the repository layer, depending on system configuration and performance requirements.

### Content Delivery Networks

In various implementations, the system utilizes a content delivery network (“CDN”) to store and distribute media assets generated from enriched lead records. A CDN refers to a distributed storage and delivery infrastructure that enables efficient access to digital content through geographically dispersed servers or storage nodes. The CDN may be used to cache, store, and serve media assets in formats such as JPEG, PDF, HTML, MP4, or other supported types.

Once a media asset is generated for a given lead record, it can be uploaded to the CDN and stored in association with a unique identifier. The system may organize media assets in a file structure, object store, or content-addressable store, depending on the configuration of the CDN. Each stored media asset can be associated with a unique link, such as a URL or tokenized reference, that enables retrieval and access to the asset on demand. These links may be public, protected with access controls, or time-limited depending on privacy or compliance requirements.

The CDN infrastructure can include one or more content delivery servers operating in parallel to support high availability, load balancing, and fault tolerance. Media assets may be replicated across multiple nodes to improve access speed and redundancy. In some implementations, content generation applications may directly interface with CDN components to upload and register assets, while in other configurations, a separate orchestration layer may handle media publishing.

By leveraging a CDN, the system supports scalable, low-latency delivery of media assets across geographic regions and device types, facilitating real-time or near-real-time engagement with the entities described by the lead records. The CDN also enables persistent availability of personalized content, which can be used for asynchronous messaging, follow-up interactions, or archival reference.

### User Interface and Administrative Tools

In various implementations, the system includes one or more user interfaces (UIs) and administrative consoles designed to facilitate user oversight, configuration, and manual intervention in connection with the enrichment, media generation, and delivery processes. These interfaces may be rendered through browser-based dashboards, standalone applications, or embedded modules within CRM platforms and may be accessed via input/output devices interfaced through I/O controller 550.

A user interface may present a tabular or card-based view of incoming and processed lead records, with visual indicators reflecting enrichment status, confidence scores, data provenance, and completeness metrics. Confidence levels for individual enriched fields may be displayed using graduated icons, color coding, or numerical scores, allowing users to quickly assess data reliability. For example, if enrichment data for a field such as estimated property value is derived from multiple conflicting sources, the interface may show the selected value along with a breakdown of alternatives, their respective trust scores, and a justification for source selection based on system heuristics or ML-driven ranking.

The system may also provide override functionality, enabling users to manually modify enrichment results, approve or reject proposed media assets, and intervene in downstream workflows. Upon selecting a lead record, the user may view a generated media asset in preview mode, edit data fields, re-render the media using a selected template, or suppress delivery. Overrides may be logged and version-controlled for audit purposes. In some configurations, role-based access control (RBAC) may restrict editing capabilities to privileged users, while allowing read-only views to general users or operators.

Administrative tools may also expose analytics dashboards for monitoring engagement and delivery performance. Metrics may include delivery success rates across communication channels (e.g., SMS, email), open and click-through rates for media links, bounce or failure logs, and time-based engagement curves. These data may be visualized as time-series graphs, cohort comparisons, or geographical heat maps. Users may filter by campaign, template, date range, or lead segment to isolate performance patterns or identify anomalies. The system may also expose downloadable reports or integration endpoints for external analytics tools.

The UI may support real-time status monitoring for asynchronous operations, including enrichment job progress, queued render tasks, CDN upload status, and delivery event logs. Notification mechanisms such as alert banners or audit feeds may inform the user of system events requiring attention, such as failed enrichments, duplicate records, or template rendering errors. Where applicable, the system may support batch approval workflows, user comments on specific records, and configurable approval queues for high-touch campaigns or regulated industries.

### Machine Learning and Artificial Intelligence

In some implementations, the system incorporates machine learning (“ML”) or artificial intelligence (“AI”) subsystems for improving performance and decision quality at multiple stages of the data enrichment and media generation pipeline. These ML components may be implemented in hardware-accelerated environments, with compute workloads distributed across one or more general-purpose graphics processing units (“GPUs”), tensor processing units (“TPUs”), field-programmable gate arrays (“FPGAs”), or application-specific integrated circuits (“ASICs”). In this context, an ASIC is optimized for AI/ML operations. As used herein, an “AI Accelerator” is a graphics processing unit, tensor processing unit, field programmable gate array, application-specific integrated circuit optimized for AM/ML, or other component used to accelerate AI processing, as would be understood by one of ordinary skill in the art. Each hardware accelerator may be connected to system memory via high-bandwidth interconnects. For example, the high-bandwidth interconnect may be: PCI Express Gen3, PCIe Gen4, PCIe Gen5, PCIe Gen6 with PAM4 signaling, and the projected PCIe Gen7; NVIDIA's NVLink v1, v2, v3, and v4, as well as the NVLink Switch System for GPU-to-GPU and GPU-to-CPU communication; Compute Express Link (CXL) versions 1.0, 1.1, 2.0, and 3.0, which provide cache coherence and memory pooling over PCIe; CCIX (Cache Coherent Interconnect for Accelerators); Gen-Z memory-semantic fabrics for disaggregated architectures; OpenCAPI for high-speed coherent communication between IBM POWER processors and accelerators; AMD Infinity Fabric and Infinity Fabric 3.0 for CPU-GPU interconnects; AMD Infinity Cache for on-die bandwidth amplification; High Bandwidth Memory standards including HBM2, HBM2e, and HBM3; GDDR5, GDDR6, and GDDR6X for graphics memory; DDR5 and LPDDR5X for high-speed main and mobile memory; NVIDIA SXM and NVSwitch for high-throughput multi-GPU communication; InfiniBand HDR, NDR, and XDR for RDMA-based inter-node communication; Ethernet in 100 GbE, 200 GbE, 400 GbE, and 800 GbE variants for data center fabrics; NVMe over Fabrics for remote SSD access; Intel Omni-Path; and on-chip and intra-SoC interconnects such as ARM's AXI, Intel's Coherent Mesh Network, TSMC's CoWoS and InFO packaging interconnects, and Apple's UltraFusion chip-to-chip bus. The hardware accelerators can communicate with the main processor and I/O controller via system bus 530. In cloud-hosted configurations, ML processing may be performed on remote compute instances provisioned with dedicated GPU or TPU resources, such as NVIDIA A100, H100, or Google TPU v4 hardware.

The system can use supervised or unsupervised ML models for lead classification, such as segmenting incoming records into behavioral clusters (e.g., high-intent vs. low-intent), demographic bands, or predicted lifecycle stages. These models may be trained using labeled historical data, including past lead conversion rates, engagement patterns, enrichment outcomes, and transaction history. Feature vectors may be extracted from raw and enriched lead data and processed in GPU memory using CUDA-enabled data pipelines or TensorFlow/PyTorch runtimes. Intermediate feature representations may be stored in high-throughput memory modules (e.g., GDDR6X, HBM2e) to support real-time inference across large batches of lead records.

For data disambiguation and deduplication, the system may use clustering algorithms or neural similarity models (e.g., Siamese networks or BERT embeddings) to detect overlapping records with inconsistent identifiers. These models can be trained on pairwise comparisons across structured fields such as name, address, phone number, and email address. During inference, similarity scores are computed using vectorized representations in GPU memory and routed through decision logic executed on the main CPU or an integrated TPU coprocessor. In-memory hash maps or bloom filters may be maintained in high-speed RAM or L3 cache to enable low-latency duplicate detection in streaming or micro-batch ingestion modes.

The system may further implement dynamic template selection using reinforcement learning or content optimization models that maximize engagement metrics (e.g., open rates, click-through rates, or conversion probabilities). Candidate templates may be scored in real-time based on a lead's classification, historical cohort performance, and contextual signals (e.g., time of day, location). These predictions may be generated using tree-based ensemble models (e.g., XGBoost, LightGBM) or deep neural networks accelerated by TPUs. Once a template is selected, the system may apply conditional logic to populate messaging components, call-to-action phrasing, or product selection criteria based on inferred engagement likelihood. Template metadata, scoring logs, and selection outcomes may be cached in DRAM or NVRAM modules to support replayability and model evaluation.

For predictive analytics and next-best-action (NBA) modeling, the system may integrate ML models that anticipate downstream user behavior and recommend optimal follow-up sequences. These models can include temporal sequence models (e.g., LSTM, Transformer-based architectures) trained on historical lead timelines to predict likelihood of response, conversion, or churn. Inference is executed on GPU or TPU cores and results are relayed to CRM or campaign automation modules via the I/O controller 550. Based on the model output, the system can dynamically assign leads to re-engagement paths, defer media delivery, or escalate records to human operators. Weight matrices, hidden states, and prediction outputs are managed in memory pools local to the inference engine, minimizing latency and bus contention.

The integration of ML-enhanced subsystems with dedicated hardware accelerators enables the system to execute compute-intensive models in real time, process large volumes of leads at scale, and make adaptive content and routing decisions based on continuously updated data. By leveraging GPUs, TPUs, and optimized memory and bus architectures, the system supports high-throughput inference, model training, and streaming analytics across its entire lead processing and media generation pipeline.

### Security Architecture and Privacy Compliance

In various implementations, the system includes integrated security and compliance mechanisms designed to protect sensitive data, enforce access controls, and support conformance with privacy regulations such as the General Data Protection Regulation (“GDPR”) and the California Consumer Privacy Act (“CCPA”). These mechanisms are applied across the system's data ingestion, enrichment, storage, media generation, and delivery layers.

All data transmissions between system components, including API calls to enrichment providers, uploads to content delivery networks, and delivery of media links to consumer devices, may be secured using transport layer encryption protocols such as TLS 1.2 or TLS 1.3. Data at rest, including stored lead records, enrichment results, template metadata, and generated media assets, may be encrypted using symmetric encryption algorithms such as AES-256, with encryption keys managed by a hardware security module, key management service, or cryptographically isolated key vault.

To support privacy compliance obligations under GDPR, CCPA, and related frameworks, the system may implement functionality for opt-out tracking, data subject access requests, and record suppression. Lead records may be flagged with opt-out status indicators that suppress downstream enrichment, media generation, or delivery. Data subjects may request access to, correction of, or deletion of their stored data via authenticated workflows, which may be processed automatically or via administrator approval. The system may log all such requests and their outcomes for auditability. Where required, pseudonymization or tokenization techniques may be applied to reduce data identifiability during processing.

Role-based access control is enforced across all user-accessible modules, including administrative dashboards, enrichment override tools, and media asset viewers. Each user may be assigned one or more roles (e.g., analyst, administrator, compliance officer), with access rights defined per role and scoped to particular data categories, workflows, or system functions. Authentication may include multi-factor mechanisms, and sessions may be monitored for anomalous behavior or policy violations. In distributed deployments, access control decisions may be enforced by edge nodes or federated identity systems to ensure consistent policy application.

All material user actions and system events may be recorded in audit logs, which may include timestamps, user identifiers, operation codes, affected resources, and result statuses. These logs may be stored in immutable or tamper-evident storage backends to facilitate forensic review, compliance reporting, and operational debugging. In some configurations, audit data may be exported to third-party security information and event management platforms or retained in accordance with internal data retention policies. Security logs may also support alerting workflows, triggering notifications or escalation protocols based on configurable thresholds or detected anomalies.

### Workflow Automation and Integration Points

The system may include native support for integration with third-party platforms commonly used in customer acquisition, marketing, lending, and communication workflows. Integration with CRM systems such as Salesforce, HubSpot, or Zoho may be implemented via RESTful APIs, webhooks, or direct database connectors. The system may ingest lead records from CRM exports, synchronize enrichment and delivery status back into CRM pipelines, and trigger downstream processing based on CRM stage transitions, record updates, or user actions. In some configurations, the system may register custom CRM fields to store media asset links, enrichment summaries, or engagement metrics.

Integration with marketing automation platforms such as Marketo, Eloqua, or Pardot enables the system to support campaign-based delivery logic and lead scoring enhancements. Enriched attributes or predictive model outputs may be pushed into marketing platforms for segmentation or behavioral targeting. Conversely, campaign triggers or workflow conditions in those platforms (e.g., email opened, form submitted) may invoke the system's media generation or re-engagement logic through API callbacks. The system may also integrate with communication gateways including Twilio, SendGrid, Amazon SES, and others to deliver media links via SMS, MMS, email, RCS, or push notifications. Configuration parameters may control message content, channel priority, delivery throttling, and retry logic.

The system may further interface with loan origination systems and automated underwriting systems used in financial services. Enriched lead records containing eligibility indicators, LTV ratios, or credit attributes may be pushed into LOS workflows to prepopulate applications or initiate soft pulls. The system may retrieve product eligibility criteria or rate card data from underwriting engines to inform template selection or conditional messaging. Bidirectional data flows between the system and financial platforms support both marketing and prequalification use cases while ensuring data consistency and minimizing manual entry.

The system may support both batch and real-time processing architectures. In batch mode, lead records may be ingested and queued in bulk (e.g., from CSV uploads or CRM exports), with enrichment, classification, media generation, and delivery performed as scheduled jobs or background tasks. Batch processing allows for higher throughput and cost optimization when latency is not critical. In contrast, real-time or near-real-time modes support ingestion via streaming APIs or webhooks, with sub-second to single-digit second latency between lead arrival and media delivery. Event-driven processing pipelines may use message brokers (e.g., Kafka, SQS) and trigger-based logic to react to inbound events, enabling dynamic engagement. Real-time modes are particularly suited for time-sensitive use cases such as rate lock offers, triggered re-engagements, or borrower response handling. Latency thresholds and system configurations may be adjusted to balance responsiveness against compute cost, enrichment API latency, and template rendering performance.

### Scalability and Infrastructure

The system architecture is designed to support horizontal scaling across all major functional components, including lead ingestion, data enrichment, classification, media generation, and delivery coordination. Each service may be stateless and deployed in multiple instances behind a load balancer, allowing compute capacity to scale linearly with workload volume. For example, enrichment services can be instantiated as parallel workers that independently query external APIs and apply transformation logic on discrete lead records. Similarly, media generation nodes may operate concurrently to render templates for thousands of enriched records in parallel, using GPU-accelerated rendering engines or containerized rendering pipelines.

The system may be deployed using container orchestration frameworks such as Kubernetes, OpenShift, or Docker Swarm, with individual components encapsulated in container images that can be versioned, replicated, and scheduled across a cluster. This deployment model supports dynamic autoscaling based on CPU, memory, queue depth, or custom system metrics. Kubernetes-native features such as rolling updates, health checks, and affinity rules may be used to ensure high availability and resource efficiency. In cloud environments, services may be distributed across availability zones or regions, and persistent state (e.g., lead records, enrichment results) may be stored in cloud-native databases or object stores with regional replication.

Content delivery may utilize multi-tiered CDN infrastructure to reduce latency and improve fault tolerance. Generated media assets are uploaded to a primary content delivery network, which may consist of origin storage backed by multiple edge caches distributed across geographic locations. Edge cache policies may support short-or long-term retention depending on asset volatility and expected access frequency. If a requested asset is not present in a local edge node, the CDN may retrieve it from the origin or a mid-tier cache. In the event of CDN unavailability, the system may support fallback mechanisms such as temporary direct links from secure object storage buckets or redundant delivery through alternate networks.

Robust error handling mechanisms are integrated at each stage of the processing pipeline. If enrichment fails—due to missing API credentials, rate limits, or lack of a reliable data match—the system may log the error, tag the record with a failure status, and optionally proceed with a degraded enrichment set using fallback logic (e.g., default values or partial templates). Template rendering modules may include input validation routines that detect malformed data, missing fields, or incompatible formats; upon detection, the system may skip the record, generate an error report, or substitute a minimal fallback asset indicating data insufficiency. For delivery failures such as bounced emails, unreachable SMS endpoints, or HTTP errors from third-party gateways, the system may implement retry logic with exponential backoff, failover routing to alternate channels, or user alerts in administrative dashboards. All failure events may be recorded in structured logs to support monitoring, root cause analysis, and compliance reporting.

### Analytics and Optimization

The system includes an analytics and optimization framework designed to measure performance of generated media assets, evaluate lead engagement behavior, and support continuous improvement of templates, delivery strategies, and enrichment models. For each media asset generated and delivered, the system may associate engagement tracking mechanisms such as embedded tracking pixels, tagged hyperlinks, or redirect-based link resolvers that enable visibility into recipient interactions. These mechanisms can detect and log events such as asset views, email opens, SMS link clicks, time-on-page, or secondary actions (e.g., button clicks or form submissions).

To support performance evaluation and controlled experimentation, the system may implement A/B testing infrastructure allowing simultaneous deployment of multiple versions of a media asset, template, or offer logic. Each test variant may be associated with a randomized or stratified subset of the eligible lead population. Engagement data collected for each variant may be stored in structured analytics tables and analyzed using statistical or machine learning models to determine which variation yields superior engagement, conversion, or downstream outcomes. Template metadata may include A/B test group identifiers, allocation ratios, and campaign-specific success criteria to enable controlled comparisons.

The analytics subsystem may expose real-time and historical performance dashboards, showing open rates, click-through rates, bounce rates, conversion rates, and lead funnel progression. Metrics may be aggregated at various levels, including by template ID, lead segment, delivery channel, campaign, and time window. Interactive visualizations may be provided through the administrative console to support pattern recognition, anomaly detection, or audience segmentation analysis. Data exports or API endpoints may allow integration with external business intelligence platforms or marketing performance tools.

In advanced configurations, performance feedback may be routed into a feedback loop used to retrain or recalibrate machine learning models within the system. For example, lead classification models may incorporate engagement-derived features (e.g., time-to-open, multi-click sequences), while content optimization models may adjust weights assigned to particular template components or message framings. Delivery scheduling algorithms may also be tuned based on observed open-time distributions. In some implementations, reinforcement learning agents or bandit algorithms may dynamically adjust allocation policies for templates or delivery channels based on real-time engagement outcomes, improving marketing efficiency over time.

### First Example

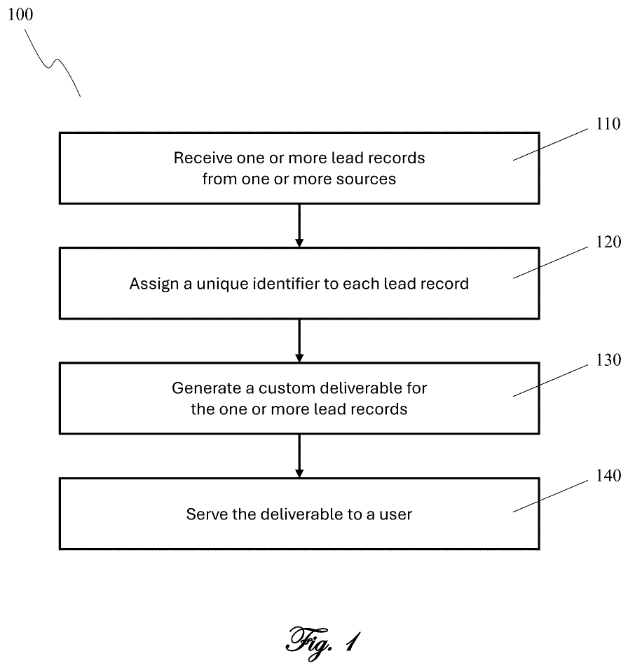

FIG. 1 illustrates an example method 100 for processing lead records and delivering corresponding media assets. Method 100 can be implemented by one or more computing systems operating individually or in coordination across a networked environment. The method can be executed in whole or in part as a batch process, an on-demand workflow, or a background service, depending on system configuration.

At step 110, the system receives one or more lead records from one or more sources. These sources can include local files, spreadsheets, external databases, CRM exports, partner platforms, or API-based integrations. Each lead record may include various fields such as contact information, property attributes, financial indicators, or other relevant data points. The system can parse and normalize the input data to prepare it for downstream processing.

At step 120, the system assigns a unique identifier to each received lead record. The identifier can be generated programmatically—for example, using a UUID generator—or derived from attributes of the lead, such as a customer number, phone number, or address. The identifier enables consistent reference to the lead record throughout the enrichment, classification, and delivery processes.

At step 130, the system generates a custom deliverable for one or more of the lead records. This deliverable can be a media asset such as a flyer, proposal, or offer, created using information associated with the record. The system can populate a predefined template with data from the lead record, optionally incorporating group-level information or additional enrichment data.

At step 140, the system serves the deliverable to a user. This can include storing the media asset in a content delivery network and exposing it via a unique link, embedding the asset into an outbound communication, or presenting the asset through a user interface. The delivery channel can include email, text messaging, CRM-integrated messaging, or other electronic distribution methods.

Method 100 provides a general framework for transforming lead data into individualized, actionable media content, which can be adapted to a wide range of use cases and system architectures.

### Second Example

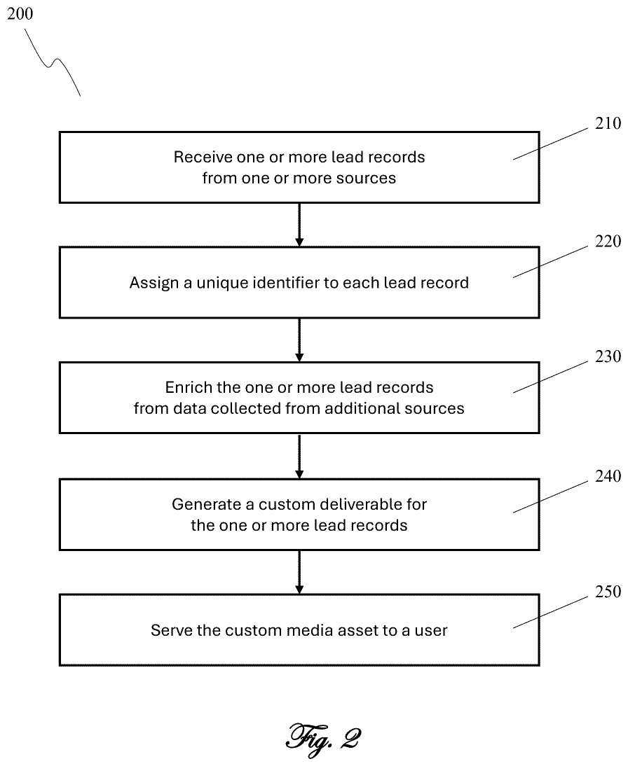

FIG. 2 illustrates an example method 200 for processing and enriching lead records prior to generating and delivering custom media assets. Method 200 builds upon the general workflow of method 100 by introducing an enrichment stage that enhances the utility and accuracy of the data set prior to content generation. The method can be implemented using one or more computing systems configured to operate in a distributed or centralized environment.

At step 210, the system receives one or more lead records from one or more sources. As in the prior example, these sources may include CRM platforms, uploaded spreadsheets, direct integrations with external services, or other data providers. Each lead record may contain partial or incomplete data.

At step 220, a unique identifier is assigned to each received lead record. The identifier allows consistent referencing throughout all processing stages and may be internally generated or derived from characteristics of the record, depending on system configuration.

At step 230, the system enriches the lead records using data collected from one or more external sources. This enrichment can include appending missing or supplemental information to the lead record, such as contact verification, phone number validation, property valuation, estimated debt, credit risk indicators, or other relevant attributes. Enrichment sources may be accessed via API calls, SFTP transfers, or other programmatic interfaces. The system can query multiple sources for a given data field, select the most reliable result based on observed accuracy or conversion rates, and integrate the selected data into the corresponding lead record. Where a given source fails to produce a usable result, the system can fall back to secondary or tertiary sources. In some cases, enrichment results may trigger downstream logic used for classification, segmentation, or personalization.

At step 240, a custom deliverable is generated for one or more enriched lead records. This may include creating a personalized flyer, quote, proposal, or other media asset using both the original and enriched data fields. The system can populate templates with dynamic values tailored to the characteristics of the individual lead and any relevant grouping data.

At step 250, the system serves the custom deliverable to a user. This can involve storing the media asset in a CDN and generating a unique link, inserting the asset into a communication workflow, directly sending the user an offer, or displaying the asset through a user interface. Media delivery may be triggered by CRM events or other automated conditions and can be executed through various electronic channels, including SMS, email, RCS, or application-based messaging.

Method 200 enhances the baseline record-to-media workflow by incorporating dynamic enrichment to improve the completeness, reliability, and specificity of lead data, thereby enabling more accurate targeting and more relevant messaging.

### Third Example

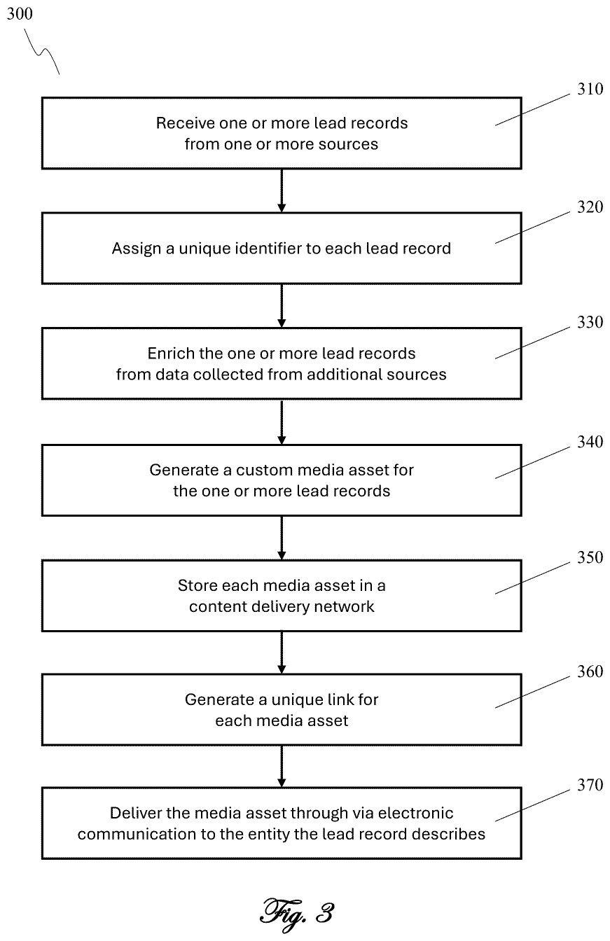

FIG. 3 illustrates method 300, an example of a comprehensive, automated workflow for processing lead records, enriching their associated data, generating personalized media assets, and delivering those assets directly to the corresponding entities via electronic communication. This method reflects an integrated system architecture designed for minimal manual intervention, reduced processing time, and enhanced message targeting.

At step 310, the system receives one or more lead records from one or more sources. These records can be imported from spreadsheets, CRM platforms, third-party data aggregators, or API-based data streams. The input format may vary, and records may contain incomplete or inconsistent data at the time of ingestion.

At step 320, the system assigns a unique identifier to each lead record. This identifier can be a UUID generated by the system or derived from record-specific attributes such as a phone number, email address, or customer reference. The identifier enables deterministic reference to the lead throughout all stages of processing, enrichment, and delivery.

At step 330, the lead records are enriched using data collected from additional sources. These sources can include public or proprietary databases accessed through APIs, SFTP, or other data protocols. Enrichment can append data such as verified contact information, property characteristics, debt balances, valuation estimates, or credit indicators. Where multiple enrichment sources are available, the system can apply logic to select the most reliable or highest-converting source. Enrichment may also include preprocessing logic to calculate derived fields such as equity ratios or eligibility thresholds used in downstream logic. If multiple records conflict or share identifiers, the system may apply disambiguation techniques—such as clustering, probabilistic matching, or rule-based comparisons—to either separate entities or discard records to avoid compromising data integrity or privacy.

At step 340, the system generates a custom media asset for one or more enriched lead records. This asset can take the form of a marketing flyer, offer sheet, proposal, or other visual document. The system can populate a configurable template using both the enriched data and any unique record-level attributes. Personalization logic may include variable pricing, location-specific offers, or eligibility-based messaging. The media asset is rendered in a standard format, such as image (such as a JPEG, GIF, or TIFF file), a video (such as an MP4, VID, or AVI file), a sound clip (such as an MP3 file), or a document (such as an XLS, DOC, DOCX, PDF file), suitable for transmission across a range of communication channels.

At step 350, the media asset is stored in a CDN or similar storage architecture optimized for fast retrieval and scalability. Each asset is saved with a deterministic file path or identifier, enabling programmatic access without requiring persistent storage on user-facing devices or services.

At step 360, the system generates a unique link for each media asset. This link can be constructed using the lead record's unique identifier and the corresponding file path in the CDN. The link may be publicly accessible or protected through authentication tokens, time-limited access, or other security measures depending on privacy and compliance requirements.

At step 370, the system delivers the media asset to the entity described by the lead record via an electronic communication channel. The delivery can be triggered manually or automatically, for example, when a CRM workflow stage is updated or when the system detects that the asset is ready for deployment. Supported communication channels can include SMS, MMS, email, RCS, or in-app messaging. The unique media link is embedded into the message body, allowing the recipient to view the personalized content directly from their device. The system can track delivery status, link engagement, and user interaction metrics for subsequent analysis.

Method 300 provides a full-stack, automated framework for converting raw lead data into customized, enriched media content and ensuring direct, timely, and individualized delivery to each lead entity. This enables reduced turnaround time, enhanced targeting accuracy, and increased scalability for sales and marketing operations.

### Fourth Example

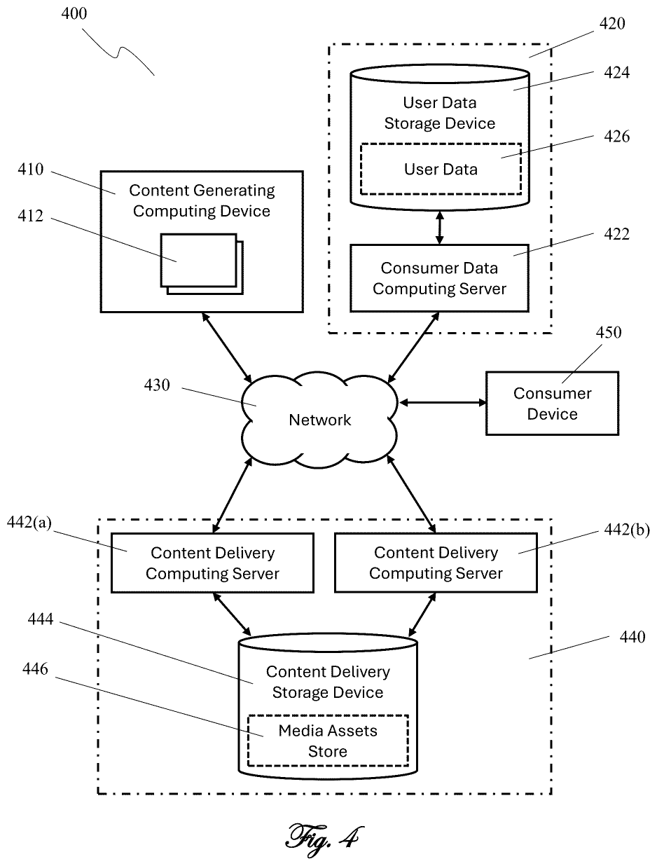

FIG. 4 illustrates an example of system 400, a distributed computing environment configured to receive lead data, enrich the data using external sources, generate personalized media assets, and deliver those assets to individual consumers over a network. The system architecture includes multiple interconnected components to support reliability, scalability, and real-time data processing.

A user interacts with content generating computing device 410, which can be a desktop computer, laptop, or tablet. The device 410 operates one or more software applications 412, which assist the user in managing lead records, configuring templates, initiating enrichment requests, and generating media assets. Examples of such applications 412 may include a CRM platform, a browser-based marketing automation tool, or a proprietary lead processing application. These applications may store lead records locally or access remote storage.

The content generating computing device 410 communicates over network 430, which may include one or more public or private data networks, to access enrichment data. The enrichment data is sourced from data source network 420, which includes a consumer data computing server 422 responsible for receiving, processing, and responding to data enrichment requests submitted by applications 412. The consumer data computing server 422 retrieves relevant user data 426 from user data storage device 424. Device 424 may be implemented as a standalone database or data warehouse, or it may be integrated within consumer data computing server 422. The user data 426 may include contact validation data, property records, financial attributes, or other information used to complete or enhance the lead record.

Upon collecting the relevant data, consumer data computing server 422 transmits the enriched data back to the requesting application(s) 412 via network 430. The applications 412 incorporate the enrichment data into the lead record and generate a personalized media asset based on the resulting information. This asset may be a marketing flyer, product offer, or other customized deliverable rendered in a standardized format such as JPEG or PDF.

The generated media asset is then transmitted to content delivery network 440. Transmission is routed through one of two content delivery computing servers, 442(a) or 442(b), which are configured in parallel to provide high availability and fault tolerance. While two servers are illustrated, the system is operable with a single server in alternative configurations. Each content delivery computing server communicates with a content delivery storage device 444, where the media asset is stored within media asset store 446. This storage system is optimized for quick retrieval and large-scale access, allowing for rapid distribution of media assets on demand.

A unique link corresponding to the stored media asset is generated either by the applications 412 or by one of the devices within content delivery network 440. This link references the specific media asset and enables direct access by the consumer. Applications 412 then transmit the unique link to consumer device 450 using an electronic communication method over network 430. Transmission methods may include SMS, email, messaging applications, or other digital communication platforms. In alternative configurations, the link may be transmitted via a direct channel between content generating computing device 410 and consumer device 450.

In this manner, the personalized media asset is delivered to consumer device 450 in a manner that is efficient, scalable, and capable of supporting high levels of customization. The described system 400 enables seamless integration of lead management, data enrichment, asset generation, and content delivery across distributed components.

### Fifth Example

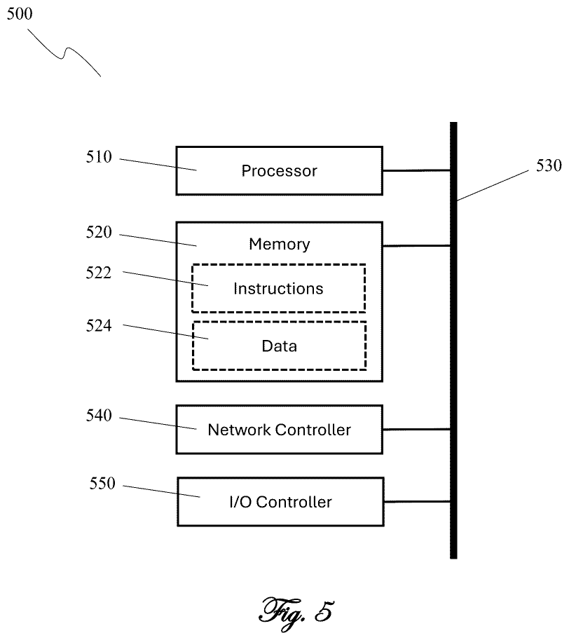

FIG. 5 illustrates computing device 500, which is configured to perform one or more operations associated with receiving, enriching, transforming, and delivering lead data and personalized media assets. This device may be implemented as a workstation, server, virtual machine, or cloud-hosted instance, and may represent either a user-facing system or a backend processing node within the broader system architecture.

Computing device 500 includes processor 510, memory 520, data bus 530, network controller 540, and I/O controller 550. Processor 510 executes instructions 522 stored in memory 520 to carry out the core functionality of the system. These instructions may include logic for ingesting and parsing lead records, initiating data enrichment requests via external APIs, performing grouping and classification operations, generating customized media content, and managing delivery workflows. Data 524 in memory 520 may include lead record content, enrichment results, template definitions, media assets, and tracking metadata.

The components of computing device 500 communicate over data bus 530, which provides internal connectivity between the processor 510, memory 520, network controller 540, and I/O controller 550. Bus 530 may implement one or more high-speed interconnect protocols such as PCIe, QPI, or similar. Network controller 540 is shown as being directly connected to data bus 530 and is configured to facilitate communication with external systems over network 430. This includes transmitting enrichment requests to consumer data computing server 422, receiving enriched data from user data storage device 424, and uploading generated media assets to content delivery network 440. In some configurations, network controller 540 may alternatively be connected through I/O controller 550 rather than directly on the bus, allowing integration with modular or external I/O subsystems.

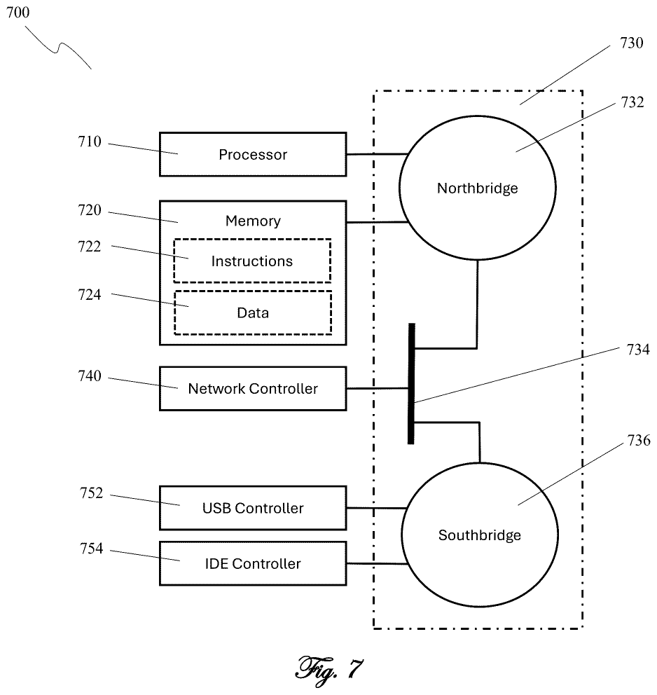

Data bus 530 may comprise several specialized pathways, with various data control circuits, integrated circuits, and logic that may isolate some data traffic as drawn on data bus 530 from other components. In some implementations, integrated circuits and/or logic may exist that control when and how components on the bus 530 communicate with one another. For example, FIG. 7 shows a possible implementation with an exemplary Northbridge/Southbridge architecture.

I/O controller 550 may connect to data bus 530 and manages communication between the computing device and external input/output devices used by the user. Through I/O controller 550, a user may interact with the system via a keyboard, mouse, touchscreen, or graphical interface to initiate lead import, review enrichment results, select media templates, approve deliverables, and monitor distribution status. The user interface rendered through these devices may present real-time system feedback and permit manual intervention or overrides when needed, such as resolving ambiguous records or approving enrichment sources. While I/O Controller 550 is shown as being on data bus 530, it may be connected directly to the processor 510 instead of bus 530 through a dedicated connection (not shown), depending on architecture.

In this example, computing device 500 plays a central role in orchestrating the overall method by receiving lead records from local input or external systems, assigning unique identifiers to enable persistent and traceable handling, managing enrichment processes by communicating with remote data providers, executing logic to group leads and generate tailored media assets, uploading media to the content delivery infrastructure and generating unique links, and delivering those links to consumer devices using automated communication channels. The device also enables direct user interaction to configure, monitor, and control system behavior. The inclusion of both I/O controller 550 and network controller 540—whether directly on bus 530 or routed through I/O controller 550—permits computing device 500 to operate as both an automated processing platform and an interactive tool for managing end-to-end lead transformation and media delivery workflows.

### Sixth Example

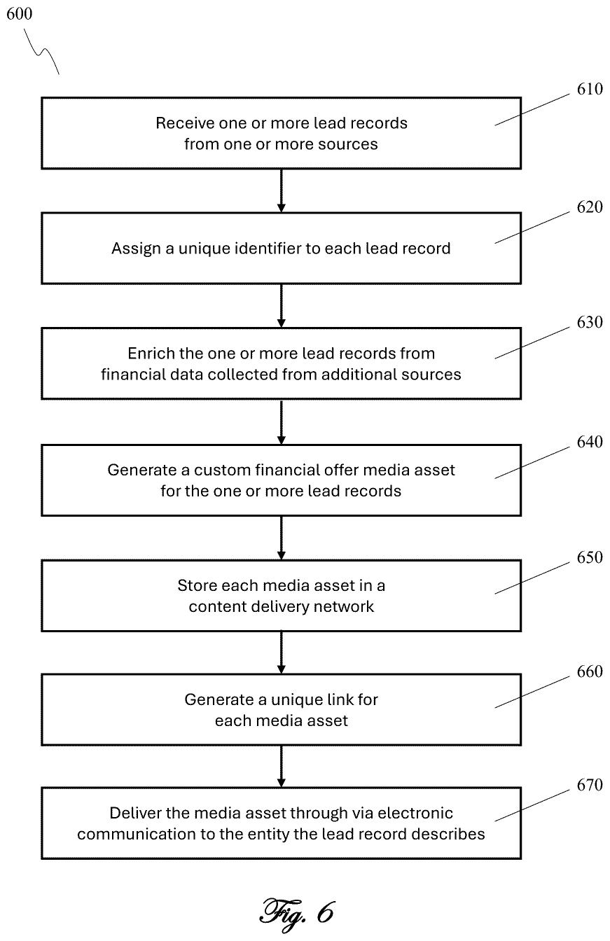

FIG. 6 illustrates method 600, which describes a specialized workflow for generating and delivering personalized financial offer media assets, particularly in the context of mortgage, refinancing, and related financial services. Method 600 may be implemented by lending institutions, brokers, or fintech platforms seeking to deliver targeted refinance proposals, loan prequalification offers, or rate-based marketing content to prospective or existing clients based on enriched financial and property data. This method is particularly well suited for environments where rapid responsiveness to changes in borrower circumstances, interest rates, or credit status is critical to client acquisition and retention.

At step 610, the system receives one or more lead records from one or more sources. These records may originate from third-party lead aggregators, loan comparison websites, CRM exports, proprietary application pipelines, or direct customer interactions. Lead records can include preliminary or partial data such as customer name, contact details, property address, estimated loan balance, or initial inquiry metadata.

At step 620, the system assigns a unique identifier to each lead record. This identifier enables reliable tracking and correlation of enriched data, media assets, and outbound communications. The identifier may be a UUID generated by the system or derived from intrinsic attributes such as property address, borrower ID, or application number.

At step 630, the lead records are enriched with additional data collected from internal systems or external data sources. For mortgage and refinance scenarios, enrichment may include automated valuation model data, current mortgage terms, lien position, credit summary indicators, payment history, loan-to-value ratio, debt-to-income ratio, and regional lending constraints. The system may integrate with credit bureaus, property data providers, title systems, and rate engines using secure API connections. Enrichment logic can include both direct data retrieval and derived calculations necessary for preliminary underwriting and offer construction. If conflicting or incomplete data is detected, the system may apply rules or machine learning models to reconcile records or suppress output until integrity thresholds are met.

At step 640, the system generates a custom financial offer media asset for each enriched lead. The media asset may include a refinance offer flyer, prequalification summary, payment reduction comparison, rate lock proposal, or promotional offer with estimated monthly payments and term options. The system can dynamically populate the media asset using the enriched financial and property data, offer templates, regional rate tables, and preconfigured business rules. Disclosures, regulatory notices, and conditional approval language can be embedded based on jurisdiction and borrower profile.

At step 650, the generated media asset is stored in a CDN for scalable, low-latency retrieval. The CDN infrastructure may include multiple content delivery servers to support redundancy and high availability. Each media asset is saved under a unique path or object key tied to the lead's unique identifier.

At step 660, the system generates a unique link to access the stored media asset. The link may be a persistent URL or tokenized reference, optionally protected by access controls, time limits, or encryption to ensure compliance with privacy and financial regulations. The link allows secure retrieval of the personalized media content on demand by the recipient.

At step 670, the system delivers the media asset to the entity described by the lead record using an electronic communication method. Delivery channels may include SMS, email, secure messaging platforms, or embedded CRM workflows. Communications may be triggered automatically upon media generation or initiated as part of a broader campaign. The system may incorporate branding, call-to-action messaging, and contact options into the delivery message, along with the unique link to the offer.

This method provides substantial operational benefits for the mortgage and financial services industries. It enables institutions to generate high volumes of customized, compliant financial offers in near real-time based on up-to-date borrower and market data. By continuously processing lead data in batches or on a rolling basis, lenders can maintain a proactive outreach posture and immediately respond to key triggers such as credit inquiries, rate changes, or equity position shifts. This allows a lender or broker to be the first to engage with a prospective borrower at the moment of financial decision-making —often a critical advantage in competitive lending environments.

Moreover, the automation of enrichment, asset generation, and delivery allows institutions to scale outreach efforts without proportionally increasing staff hours or manual effort. The system can process thousands or millions of records in a batch, each resulting in a fully personalized offer and delivery event. This brute-force marketing capability, when combined with precision targeting and enriched data, supports both lead conversion and retention strategies. It also reduces the time between lead capture and offer presentation from days to minutes, improving user experience, campaign responsiveness, and overall marketing ROI in refinance, purchase, home equity, and other lending verticals.

### Seventh Example

FIG. 7 illustrates a representative implementation of computing device 700 configured using a traditional Northbridge/Southbridge architecture. In this configuration, computing device 700 performs the same core operations previously described with respect to computing device 500 in FIG. 5, including receiving, enriching, transforming, and delivering lead data and personalized media assets.

Computing device 700 includes processor 710; memory 720 with instructions 722 and data 724 stored thereon; network controller 740; data control logic 730, including Northbridge 732, PCI bus 734, and Southbridge 736; USB controller 752; and IDE controller 754. Processor 710 executes instructions 722 stored in memory 720 to carry out the core functionality of the system. These instructions may include logic for ingesting and parsing lead records, initiating data enrichment requests via external APIs, performing grouping and classification operations, generating customized media content, and managing delivery workflows. Data 724 in memory 720 may include lead record content, enrichment results, template definitions, media assets, and tracking metadata.

The components of computing device 700 communicate with data control logic via Northbridge 732, part of the data control logic 730. This provides internal connectivity between the processor, memory, and PCI bus 734. PCI bus 534 may implement one or more high-speed interconnect protocols such as PCIe or similar. Network controller 540 is shown as being directly connected to PCI bus 734 and is configured to facilitate communication with external systems over network 430. This includes transmitting enrichment requests to consumer data computing server 422, receiving enriched data from user data storage device 424, and uploading generated media assets to content delivery network 440. In some configurations, network controller 740 may alternatively be connected through USB controller 752 rather than directly on PCI bus 734, allowing integration with modular or external subsystems.

USB controller 752 and IDE controller 754 are connected to Southbridge 736, which is part of data control logic 730. USB controller 752 and IDE controller 754 manage communication from I/O devices. For example, through USB controller 752, a user may interact with the system via a keyboard, mouse, touchscreen, or graphical interface to initiate lead import, review enrichment results, select media templates, approve deliverables, and monitor distribution status. The user interface rendered through these devices may present real-time system feedback and permit manual intervention or overrides when needed, such as resolving ambiguous records or approving enrichment sources. IDE controller 754 may communicate with hard drives to retrieve and store data and instructions persistently. Other controllers may be connected to the Southbridge, such as SATA controllers (not shown) or other interfaces, as would be understood by one of ordinary skill in the art.

In this example, computing device 700 plays a central role in orchestrating the overall method by receiving lead records from local input or external systems, assigning unique identifiers to enable persistent and traceable handling, managing enrichment processes by communicating with remote data providers, executing logic to group leads and generate tailored media assets, uploading media to the content delivery infrastructure and generating unique links, and delivering those links to consumer devices using automated communication channels. The device also enables direct user interaction to configure, monitor, and control system behavior. The inclusion of USB controller 752 and network controller 740, permits computing device 700 to operate as both an automated processing platform and an interactive tool for managing end-to-end lead transformation and media delivery workflows.

### Eighth Example

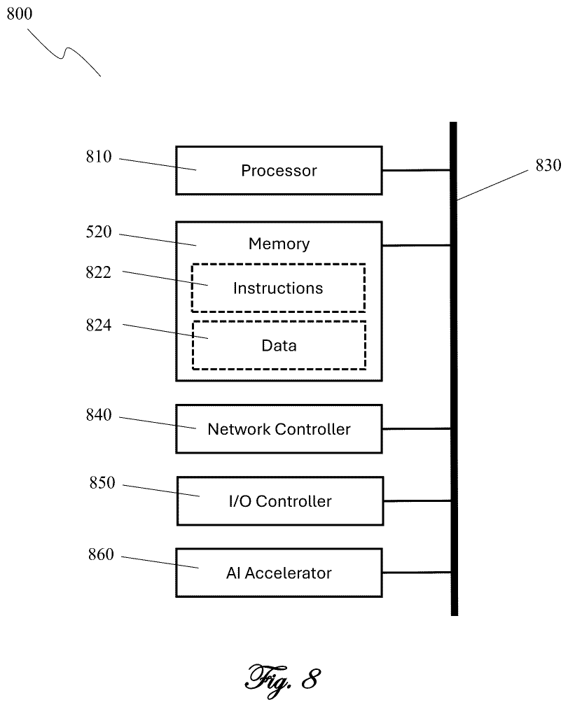

FIG. 8 illustrates computing device 800, which is configured to perform one or more operations associated with receiving, enriching, transforming, and delivering lead data and personalized media assets. This device may be implemented as a workstation, server, virtual machine, or cloud-hosted instance, and may represent either a user-facing system or a backend processing node within the broader system architecture.

Computing device 800 includes processor 810, memory 820, data bus 830, network controller 840, and I/O controller 850. Processor 810 executes instructions 822 stored in memory 820 to carry out the core functionality of the system. These instructions may include logic for ingesting and parsing lead records, initiating data enrichment requests via external APIs, performing grouping and classification operations, generating customized media content, and managing delivery workflows. Data 824 in memory 820 may include lead record content, enrichment results, template definitions, media assets, and tracking metadata.

The components of computing device 800 communicate over data bus 830, which provides internal connectivity between the processor 810, memory 820, network controller 850, I/O controller 850, and AI Accelerator 860. Bus 830 may implement one or more high-speed interconnect protocols such as PCIe, QPI, or similar. Network controller 840 is shown as being directly connected to data bus 830 and is configured to facilitate communication with external systems over network 430. This includes transmitting enrichment requests to consumer data computing server 422, receiving enriched data from user data storage device 424, and uploading generated media assets to content delivery network 440. In some configurations, network controller 540 may alternatively be connected through I/O controller 850 rather than directly on the bus, allowing integration with modular or external I/O subsystems.

Data bus 830 may comprise several specialized pathways, with various data control circuits, integrated circuits, and logic that may isolate some data traffic as drawn on data bus 830 from other components. In some implementations, integrated circuits and/or logic may exist that control when and how components on the bus 830 communicate with one another. For example, FIG. 7 shows a possible implementation with an exemplary Northbridge/Southbridge architecture. While FIG. 7 does not exemplify using an AI Accelerator, as would be understood by one of ordinary skill in the art, an AI accelerator could be connected to PCI bus 734 in FIG. 7 to achieve the same goals as system 800 while using a Northbridge/Southbridge architecture.

I/O controller 850 may connect to data bus 830 and manages communication between the computing device and external input/output devices used by the user. Through I/O controller 850, a user may interact with the system via a keyboard, mouse, touchscreen, or graphical interface to initiate lead import, review enrichment results, select media templates, approve deliverables, and monitor distribution status. The user interface rendered through these devices may present real-time system feedback and permit manual intervention or overrides when needed, such as resolving ambiguous records or approving enrichment sources. While I/O Controller 850 is shown as being on data bus 830, it may be connected directly to the processor 810 instead of bus 830 through a dedicated connection (not shown), depending on architecture.

In some implementations, computing device 800 further includes AI accelerator 860, which is connected to data bus 830 and configured to execute machine learning and artificial intelligence operations that enhance the data enrichment workflow. AI accelerator 860 may comprise a dedicated GPU, TPU, FPGA, or ASIC optimized for parallelized tensor computations and model inference tasks. Processor 810 may offload compute-intensive enrichment tasks—such as natural language processing, image classification, or predictive scoring—to AI accelerator 860 via bus 830, thereby reducing latency and improving throughput. The enrichment logic stored in memory 820 as instructions 822 may include trained models or model inference pipelines executed on AI accelerator 860, allowing the system to analyze lead records, infer missing attributes, detect anomalies, and select contextually relevant media templates in real time. AI Accelerator 860 may operate asynchronously or in parallel with the processor 810. Integration with memory 820 and coordination over bus 830 enables AI accelerator 860 to process data 824, including enrichment results and tracking metadata, with minimal contention. This architecture permits the enrichment engine to scale and improve accuracy while preserving responsiveness for concurrent operations involving I/O controller 850 and network controller 840.

In this example, computing device 800 plays a central role in orchestrating the overall method by receiving lead records from local input or external systems, assigning unique identifiers to enable persistent and traceable handling, managing enrichment processes by communicating with remote data providers, executing logic to group leads and generate tailored media assets, uploading media to the content delivery infrastructure and generating unique links, and delivering those links to consumer devices using automated communication channels. The device also enables direct user interaction to configure, monitor, and control system behavior. The inclusion of both I/O controller 850 and network controller 840—whether directly on bus 830 or routed through I/O controller 850—permits computing device 800 to operate as both an automated processing platform and an interactive tool for managing end-to-end lead transformation and media delivery workflows.

### Closing

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A computer-implemented method comprising:
receiving, by one or more computing devices, one or more lead records from one or more sources;
assigning a unique identifier to each lead record;
enriching, by the one or more computing devices, the lead records using supplemental data obtained from one or more data source networks;
generating a deliverable based on at least a portion of the lead record; and
delivering the deliverable to a recipient associated with the lead record via an electronic communication channel.

2. The method of claim 1, where the deliverable comprises a media asset that is generated by the one or more computing devices using a template populated with the lead record.

3. The method of claim 2, further comprising:
storing the media asset in a content delivery network; and
generating, by the one or more computing devices, a unique link associated with the media asset; and
wherein the deliverable comprises the unique link.

4. The method of claim 2, wherein the media asset is a customized image or video.

5. The method of claim 1, wherein the deliverable comprises a personalized refinance offer generated using a financial calculation model.

6. The method of claim 1, wherein the step of enriching the lead records comprises retrieving at least one of: property valuation, credit risk score, loan-to-value ratio, income information, or debt-to-income ratio.

7. The method of claim 1, further comprising:
determining a trustworthiness score for the supplemental data used in the enriching step using either (i) probabilistic techniques on the processor or (ii) machine learning on the processor or an AI accelerator; and
implementing rules on either the processor or the AI accelerator to (i) reject supplemental data based on its trustworthiness score, or (ii) resolve any conflicts during the enrichment step when the supplemental data has internal inconsistencies or the supplemental data is inconsistent with the lead record.

8. The method of claim 7, wherein the rules are generated by machine learning on the AI accelerator using a machine learning model.

9. The method of claim 1, wherein the lead record comprises at least one of: property valuation, credit risk score, loan-to-value ratio, income information, or debt-to-income ratio.

10. The method of claim 1, wherein the communication channel is selected based on recipient preference or prior engagement behavior.

11. A computing system comprising:
a processor;
a memory storing instructions that, when executed by the processor, cause the system to:
receive one or more lead records from one or more sources;
assign a unique identifier to each lead record;
enrich the lead records using supplemental data obtained from one or more data source networks;
generate a deliverable based on at least a portion of the lead record; and
deliver the deliverable to a recipient associated with the lead record via an electronic communication channel.

12. The system of claim 11, where the deliverable comprises a media asset.

13. The system of claim 12, wherein:
the memory further comprises instructions to:
store the media asset in a content delivery network; and
generate a unique link associated with the media asset; and
the deliverable comprises the unique link.

14. The system of claim 12, wherein the media asset is a customized image or a video.

15. The system of claim 11, wherein the instructions stored in memory to enrich the lead records comprises retrieving at least one of: property valuation, credit risk score, loan-to-value ratio, income information, or debt-to-income ratio.

16. A non-transitory machine-readable medium storing instructions that, when executed by one or more processors, cause a computing system to:
receive one or more lead records from one or more sources;
assign a unique identifier to each lead record;
enrich the lead records using supplemental data obtained from one or more data source networks;
generate a deliverable based on at least a portion of the lead record; and
deliver the deliverable to a recipient associated with the lead record via an electronic communication channel.

17. The medium of claim 16, where the deliverable comprises an image or video media asset.

18. The medium of claim 17, wherein:
the medium further stores instructions to:
store the media asset in a content delivery network; and
generate a unique link associated with the media asset; and
the deliverable comprises the unique link.

19. The medium of claim 16, the medium further stores instructions to:
determine a trustworthiness score for the supplemental data using either (i) probabilistic techniques or (ii) machine learning deployed on an AI accelerator; and
implement rules on either the processor or the AI accelerator to (i) reject supplemental data based on its trustworthiness score, or (ii) resolve any conflicts during the enrichment step when the supplemental data has internal inconsistencies or the supplemental data is inconsistent with the lead record;
wherein the rules are generated by machine learning on the AI accelerator using a machine learning model.

20. The medium of claim 16, wherein:
the lead record comprises recipient preference or prior engagement behavior; and
the lead record additionally comprises at least one of: property valuation, credit risk score, loan-to-value ratio, income information, or debt-to-income ratio;
the medium additionally comprises instructions to select the electronic communication channel based upon the lead record.
